(19) United States
(12) Patent Application Publication
(10) Pub. No.: US 2004/0141727 A1
(43) Pub. Date: Jul. 22, 2004

(54) Recording apparatus

(76) Inventor: Yuji Daijo, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 10/751,792

(22) Filed: Jan. 5, 2004

(30) Foreign Application Priority Data
Jan. 16, 2003 (JP) 2003-008549

(51) Int. Cl. H04N 5/76; H04N 5/225

(52) U.S. Cl. 386/96; 386/117

(57) ABSTRACT

A recording apparatus includes a photographing processing unit which photographs a still image of a subject during recording audio data to a recording medium, one CPU which records the audio data and generates a plurality of different kinds of notifying sound upon photographing the subject by the photographing processing unit, and another CPU which stops the audio recording to the recording medium during generating the notifying sound by the one CPU for 30 to 80 msec that does not influence the audio data recorded to the recording medium.

This Application claims benefit of Japanese Application No. 2003-8549 filed in Japan on Jan. 16, 2003, the contents of which are incorporated by this reference.

### BACKGROUND OF THE INVENTION

1. Field of the Invention

The present invention relates to a recording apparatus, and more particularly, to a recording apparatus having an audio and image recording function.

2. Description of the Related Art

As well known, a portable recording apparatus (hereinafter, referred to as an IC recorder) is put into practice, whereby an audio signal of a dictator is converted into digital data, then, the digital data is stored in a flash memory as a rewritable storage medium, and the audio data stored in the flash memory is converted into analog data and is played.

According to features of the IC recorder, by operating a predetermined operation switch, operation modes such as record, play, fast-feed, and fast-reward are selectively operated. For example, upon selecting the record operation mode, an audio data area and an index information area which are previously arranged to the flash memory store the audio data converted into the digital data, an audio-data address, index information on the recording date, etc.

Further, an IC recorder having a photographing function is produced to record an image captured by a digital camera in addition to the audio data. The IC recorder with the photographing function photographs the dictator and further photographs the material actually described by the dictator. Therefore, upon playing the audio data stored in the flash memory after that and checking the data, the dictator and the material described by the dictator can be recognized and it is very convenient.

An image and audio recording apparatus is suggested with functions of a video camera and a silver-salt camera. However, in the image and audio recording apparatus, an image is photographed by the silver-salt camera during recording the image and audio data by using the video camera and, then, operation sound such as the sound of reel-up/reward operation of a film or operation sound of a button for operating the photographing function of the silver-salt camera is recorded together with the audio data recorded to the video camera. Therefore, upon playing the data, the operation sound is very troublesome for the user.

Then, according to a patent document 1, a control circuit detects the operation sound caused by the photographing operation of the silver-salt camera, which is inputted to a microphone during recording the audio data using the video camera. The control circuit reduces the gain of a gain amplifier which amplifies an input signal from the microphone only during generating the operation sound, thereby preventing the recording of the operation sound to the video camera during recording the audio data.

### SUMMARY OF THE INVENTION

Briefly, according to the present invention, a recording apparatus includes audio recording means which records audio data, photographing means which photographs a subject during recording the audio data by the audio recording means, notifying means which generates notifying sound upon photographing the subject by the photographing means, and audio recording stop means which stops the audio recording by the audio recording means during generating the notifying sound by the notifying means.

### BRIEF DESCRIPTION OF THE DRAWINGS

FIG. 1 is a block diagram schematically showing the configuration of an IC recorder with a photographing function according to an embodiment of the present invention; and

FIG. 2 is a flowchart schematically showing the processing for the recording and photographing operation of the IC recorder with the photographing function shown in FIG. 1.

### DETAILED DESCRIPTION OF THE PREFERRED EMBODIMENTS

Hereinbelow, a description is given of an embodiment of the present invention with reference to the drawings.

(Embodiment)

An IC recorder with a photographing function is described as one example of the recording apparatus according to an embodiment of the present invention.

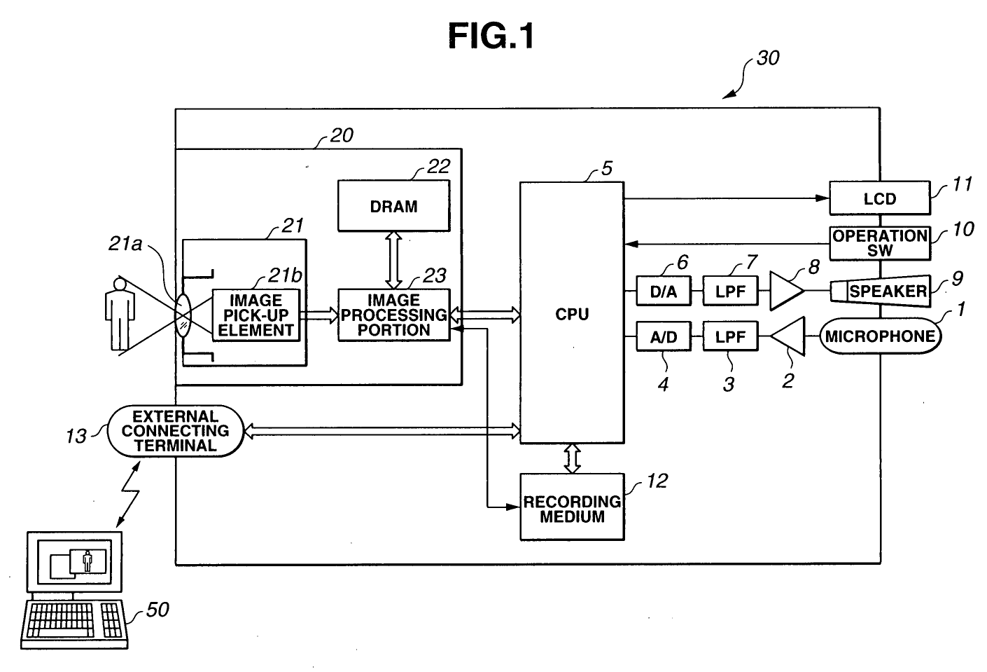

FIG. 1 is a block diagram schematically showing the configuration of the IC recorder with the photographing function according to the embodiment of the present invention.

Referring to FIG. 1, an output terminal of a microphone 1 for converting an audio signal into an electric signal is connected to an input terminal of a microphone amplifier (AMP) 2 for amplifying the electric signal from the microphone 1. An output terminal of the microphone amplifier 2 is connected to an input terminal of a low-pass filter (LPF) 3 for cutting an unnecessary high-frequency component so as to prevent the occurrence of aliasing noises. Further, an output terminal of the low-pass filter 3 is connected to an input terminal of an A/D converter 4 for converting the audio signal as an inputted analog signal into a digital signal. An output terminal of the A/D converter 4 is connected to a CPU 5.

A D/A converter 6 for converting the digital signal into the analog signal is connected to the CPU 5. An output terminal of the D/A converter 6 is connected to an input terminal of a lowpass filter (LPF) 7 for cutting an unnecessary high-frequency component so as to prevent the occurrence of aliasing noises. An output terminal of the low-pass filter 7 is connected to an input terminal of a power amplifier (AMP) 8 for amplifying the audio signal. Further, an output terminal of the power amplifier 8 is connected to an input terminal of a speaker 9 for outputting the sound of the audio signal amplified by the power amplifier 8.

The CPU 5 entirely controls an IC recorder 30 with the photographing function according to the embodiment. In the recording, the CPU 5 performs encoding processing as compressing processing of the audio signal converted into the digital signal by the A/D converter 4, and forms an audio file. In the reading, the CPU 5 performs decoding processing as decompressing of the audio file (data) encoded, and outputs the audio data to the D/A converter 6. The CPU 5 has a buffer memory (not shown) which temporarily records the audio data during recording the image photographed in the audio recording.

The CPU 5 comprises: notifying means which generates notifying sound upon photographing a subject by using a photographing processing unit 20, which will be described later; audio recording stopping means which stops the recording of the audio data by using a recording medium 12, which will be described later, during generating the notifying sound; audio data recording means which-records the audio data to the recording medium 12; photographing instructing means which instructs the photographing of a still image; control means which controls the audio data encoding means and/or the audio data recording means so as to prevent the recording, to the recording medium 12, of the audio data corresponding to the period for generating the notifying sound; audio recording means which records the audio data; temporarily stopping means which temporarily stops the audio recording upon photographing the subject using the photographing processing unit 20; re-starting means which restarts the audio recording after ending the generation of the notifying sound; and still-image recording means which records the photographed still image to the recording medium 12.

Connected to the CPU 5 are various operation switches (SW)s 10, a display device 11 comprising an LCD, the recording medium 12 comprising a flash memory, an external connecting terminal 13 comprising a USB, and the photographing processing unit 20.

The operation switches 10 control various functions of the IC recorder 30 with the photographing function according to the embodiment, and are arranged to an exterior portion of the IC recorder 30. Further, the operation switches 10 contain a record button (REC), a play button (PLAY), a stop button (STOP), a fast-feed button (FF), a fast-reward button (REW), a menu button (MENU), and release buttons having two switches of first and second release buttons, which are not shown. The operation switches 10 form the photographing instructing means for instructing the photographing the still image in the present invention.

The display device 11 display operation modes of the IC recorder 30 with the photographing function, the sequent operation situation, or various information on the present date and the like upon starting predetermined sequence operation by the switch operation of any of the operation switches 10 under the operation control of the CPU 5.

The recording medium 12 comprises a semiconductor memory such as a flash memory, and stores various setting and parameters, such as a user ID, selecting the setting of a recording mode, selecting the setting of the notifying sound, selecting the setting of the start of audio recording, and the play position of data, to be stored in the case of supplying no power to the CPU 5.

The recording medium 12 records an audio file encoded by the CPU 5 in a predetermined format of ADPCM (Adaptive Differential Pulse Code Modulation). Further, the recording medium 12 records image file (data) compressed in a predetermined format of JPEG (Joint Photographic Experts Group), which will be described later, by using an image processing portion 23 in the photographing processing unit 20.

The external connecting terminal 13 outputs, to an external output device 50 such as a PC (personal computer), the recorded audio data and the photographed image under the control of the CPU 5, and comprises a USB (Universal Serial Bus) or a fast serial bus IEEE 1394.

The photographing processing unit 20 performs the photographing processing of the subject and the compression processing of the image data photographed under the operation control of the CPU 5, and forms an image file. The main part of the photographing processing unit 20 comprises a sensor module portion 21, a DRAM (Dynamic Random Access Memory) 22, and the image processing portion 23. The photographing processing unit 20 forms photographing means which photographs the subject in the present invention.

The sensor module portion 21 has a photographing lens 21a and a solid image pick-up element 21b. A subject image is formed onto the solid image pick-up element 21b via the photographing lens 21a. The solid-image pick-up element 21b comprises a C-MOS sensor and the like, and converts the picked-up image into an electric signal. The solid image pick-up element 21b includes functions of light-measurement of the subject and the white balance adjustment. The sensor module portion 21 forms image pick-up means which picks up the still image in response to the instruction from the operation SW 10 according to the present invention.

The DRAM 22 temporarily stores the image signal converted into the electric signal by the solid image pickup element 21b. The image processing portion 23 compresses the image signal which is temporarily recorded to the DRAM 22 in a predetermined format of the JPEG, forms an image file, and outputs the file to the recording medium 12.

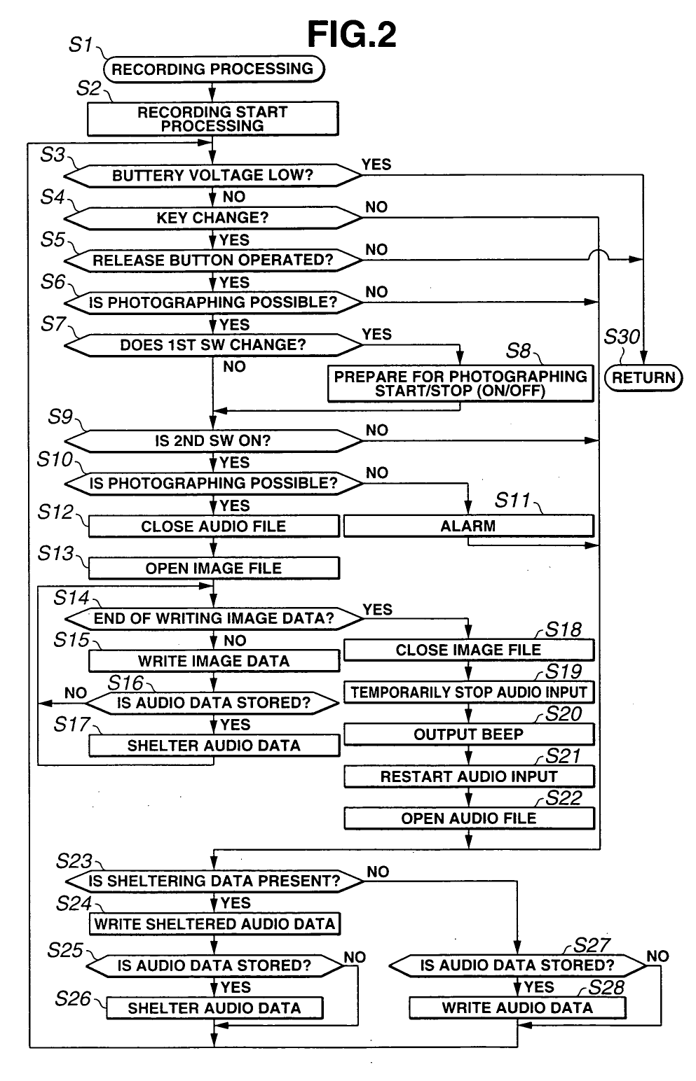

Next, the operation of the IC recorder with the photographing function will be described according to the embodiment with reference to FIG. 2. FIG. 2 is a flowchart schematically showing the processing for recording and photographing operation of the IC recorder with the photographing function according to the embodiment.

Referring to FIG. 2, the user presses the record button (REC) in the operation SWs 10 in step S1. Then, the CPU 5 turns on the power of the microphone 1 in step S2. Further, the CPU 5 performs the encoding processing of the audio data and the recording start processing which starts the generation of the audio file, and the processing sequence advances to step S3.

In step S3, the CPU 5 checks the voltage of a buttery (not shown) in the IC recorder 30, and determines whether or not the buttery voltage is a prescribed one. If it is determined that the buttery voltage is lower than the prescribed one, the processing sequence jumps to step S30 whereupon the CPU 5 performs the stop processing of the recording function and the processing sequence returns.

If the buttery voltage is the prescribed one, the processing sequence shifts to step S4 whereupon the CPU 5 determines whether or not the user operates the operation SWs 10. Specifically, it is determined whether or not the key change exists in the play button (PLAY), stop button (STOP), and release button.

If the key change does not exist in the release button in step S4, the processing sequence branches to step S23 whereupon the audio recording processing continues and the CPU 5 determines whether or not sheltered data exists in a buffer memory (not shown) of the CPU 5. If the sheltered data does not exist, the processing sequence branches to step S27 whereupon the CPU 5 determines whether or not the buffer memory in the CPU 5 has stored audio data. If the buffer memory has the stored audio memory, the processing sequence shifts to step S28 whereupon the CPU 5 writes the audio data to the recording medium 12. Then, the processing sequence returns to step S3. If the normal recording processing is performed, the CPU 5 repeats the above processing.

Back to step S4, if the key change exits in the play button (PLAY), stop button (STOP), and release buttons, the processing sequence shifts to step S5 whereupon the CPU 5 determines whether or not the key changes corresponds to the operation of the release buttons. If the key change does not correspond to the operation of the release buttons, that is, if the key change corresponds to the operation of any of the play button (PLAY) and the stop button (STOP), the processing sequence jumps to step S30 whereupon the CPU 5 performs the corresponding processing and the processing sequence returns. If the key change corresponds to the operation of the release buttons, the processing sequence shifts to step S6.

In step S6, the CPU 5 checks the capacity of the recording medium 12 and determines whether or not the photographing is possible. If the recording medium 12 does not have the capacity for recording the photographed image, the processing sequence branches to step S23. If the recording medium 12 has the sufficient capacity, the processing sequence shifts to step S7.

In step S7, the CPU 5 determines whether or not the first release SW of the release buttons changes. If it is determined that the first release SW does not change, the CPU 5 branches to step S9. If it is determined that the first release SW changes, the processing sequence shifts to step S8 whereupon the CPU 5 starts the photographing preparation such as the power feed to the photographing processing unit 20 or performs the stop processing when the first release SW is released and, then, the processing routine shifts to step S9.

In step S9, the CPU 5 determines whether or not the second release SW is switched on. If it is determined that the second release SW is not switched on, the processing sequence branches to step S23. If it is determined that the second release SW is switched on, the processing sequence shifts to step S10.

In step S10, the CPU 5 determines, by using the sensor module portion 21 in the photographing processing unit 20, whether or not the picked-up subject has a low luminance, whether or not the white balance adjustment ends, and whether or not the photographing is possible. If it is determined that the photographing is not possible, the processing sequence branches to step S11 whereupon the CPU 5 flickers, with yellow light, an LED (not shown) arranged near a finder unit in the IC recorder 30 and alarms the user of the failure of photographing and, then, the processing sequence shifts to step S23. The alarming processing may be performed by flickering the display device 11 or by using any means which can be identified by the user. If it is determined in step S10 that the photographing is possible, the processing sequence shifts to step S12.

In step S12, the CPU 5 closes the audio file and the processing sequence shifts to step S13. In step S13, the CPU 5 controls the image processing portion 23, thereby opening the photographed image file. Then, the processing sequence shifts to step S14.

In step S14, the CPU 5 determines whether the writing of the image file, that is, of the image data ends. If the CPU 5 determines that it is not ended, the processing sequence shifts to step S15 whereupon the CPU 5 writes the image data to the recording medium 12 and, then, the processing sequence shifts to step S16.

In step S16, the CPU 5 determines whether or not the recording processing is performed during writing the image data, that is, whether or not the audio data is stored. If the CPU 5 determines that the audio data is not stored, the processing sequence returns to step S14. If the CPU 5 determines that the audio data is stored, the processing sequence shifts to step S17 whereupon the CPU 5 shelters the audio data during the writing into a buffer memory (not shown) in the CPU 5 and, then, the processing sequence returns to step S14.

Back to step S14, if the writing of the image data to the recording medium 12 ends, the processing sequence branches to step S18 whereupon the CPU 5 controls the image processing portion 23, thereby closing the image file. Then, the processing sequence shifts to step S19.

In step S19, the CPU 5 temporarily performs the stop processing for inputting the audio data to the IC recorder 30 with the photographing function for 30 to 80 msec, preferably, for 40 to 60 msec, and further preferably for approximately 50 msec. In the stop processing, the power of the microphone 1 is not turned off but the CPU 5 stops the encoding of the audio data. The stop time for 30 to 80 msec does not influence the audio data recorded to the recording medium 12. The fact that “the stop time does not influence the audio data” indicates that the existence of the audio portion which is not recorded through the stop processing is not acoustically recognized upon playing the audio data later, that it does not cause any problem on the practical use, or that it is not serious. After stopping the audio input, the processing sequence shifts to step S20.

In step 20, the CPU 5 notifies the user of the end of photographing. For example, notifying sound such as beep is outputted through the PWM (Pulse Width Modulation) for 30 to 80 msec and, then, the processing sequence shifts to step S21. If the notifying sound does not influence the audio data (e.g., for 30 to 80 msec), not only the beep but also a plurality of kinds of notifying sound with different tones and intervals may be used and may be used plural times.

In step S21, the CPU 5 restarts the encoding the audio signal and restarts the audio input. Then, the processing sequence shifts to step S22 whereupon the CPU 5 opens the encoded audio file and, then, the processing sequence shifts to step S23.

In step S23, the CPU 5 shifts the processing sequence to step S24 if the buffer memory in the CPU 5 has the sheltered data, that is, if the audio data is sheltered in step S17.

In step S24, the CPU 5 writes, to the recording medium 12, the audio data sheltered during writing the image data in step S17 and, then, the processing sequence shifts to step S25 whereupon the CPU 5 determines whether or not the audio data is stored in the buffer memory in the CPU 5 during writing, to the recording medium 12, the audio data sheltered in step S24. If the CPU 5 determines that the audio data is not stored, the processing sequence returns to step S3. If the CPU 5 determines that the audio data is stored, the processing sequence shifts to step S26 whereupon the CPU 5 shelters the audio data to the buffer memory and, then, the processing sequence returns to step S3.

Since the sheltered data is temporarily written based on a plurality of multiples of a predetermined unit in step S24, the CPU 5 can eventually write the sheltered data to the recording medium 12 and can return to the usual audio recording state. After the above-mentioned writing, the CPU 5 can continuously write the audio data to the recording medium 12 until the sheltered audio data is absent.

When the photographing is performed during recording the audio data to the recording medium 12, the IC recorder 30 with the photographing function as the recording apparatus with the above-mentioned configuration in the present invention has a function for stopping the recording of the audio data to the recording medium 12 only for the generating time, from the CPU 5, of the notifying sound such as the beep indicating that the end of photographing is notified (e.g., 30 to 80 msec). Thus, the notifying sound is not recorded to the recording medium 12 and the stop time does not influence the audio data. Consequently, upon playing the audio data, the unnecessary consumption of the recording medium 12 is prevented without offensive feeling for the user. Further, the consumption of the recording medium 12 is saved.

The audio data is sheltered and recorded to the buffer memory in the CPU 5, and the sheltered and recorded audio data is sequentially recorded to the recording medium 12 after recording the image data. Consequently, the audio data to be recorded before/after recording the image data is not broken.

According to the embodiment, the notifying sound such as the beep for notifying the end of photographing is not recorded to the recording medium 12. The notifying sound may be any of operation sound or alarm sound for the photographing operation generated by the apparatus main body, such as shutter sound outputted by the CPU, focusing end sound, alarm sound upon the failure of photographing, alarm sound of the blur occurrence.

The time for stopping the recording of the audio data to the recording medium 12 is 30 to 80 msec, preferably, for 40 to 60 msec, and further preferably for approximately 50 msec. However, it is not limited to this and may be set to any time which does not influence the audio data.

Further, the recording of the audio data to the recording medium 12 is stopped by stopping the encoding processing of the audio data using the CPU 5. However, it is not limited to this and may be controlled by the CPU 5 so as not to write the audio data portion corresponding to the stop time to the recording medium 12. In other words, the audio data portion corresponding to the stop time may not be recorded to the recording medium 12.

In addition, according to the embodiment, the recording apparatus is the IC recorder with the photographing function as one example. However, it is not limited to this and, advantageously, it may be used for a device with another photographing function of a video camera and the like.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A recording apparatus comprising:
audio recording means which records audio data;
photographing means which photographs a subject during recording the audio data by the audio recording means;
notifying means which generates notifying sound upon photographing the subject by the photographing means; and
audio recording stop means which stops the audio recording by the audio recording means during generating the notifying sound by the notifying means.

2. A recording apparatus according to claim 1, wherein the photographing means photographs a still image.

3. A recording apparatus according to claim 1, wherein the notifying means generates the notifying sound at least one of when a still image is successfully photographed by the photographing means and when the still image is not successfully photographed.

4. A recording apparatus according to claim 1, wherein the notifying means generates a plurality of different kinds of the notifying sound.

5. Recording means according to claim 1, the stop time for stopping the audio recording by the audio recording stop means does not influence the audio data recorded by the audio recording means.

6. A recording apparatus according to claim 5, wherein the stop time for stopping the audio recording by the audio recording stop means is within 30 to 80 msec.

7. A recording apparatus according to claim 5, wherein the stop time for stopping the audio recording by the audio recording stop means is within 40 to 60 msec.

8. A recording apparatus according to claim 5, wherein the stop time for stopping the audio recording by the audio recording stop means is 50 msec.

9. A recording apparatus comprising:
audio data encoding means which converts input audio data to encoded audio data;
audio data recording means which records the audio data to a recording medium;
photographing instructing means which instructs the photographing of a still image;
image pick-up means which picks up the still image in response to the instruction from the photographing instructing means;
still image recording means which records the picked-up still image to the recording medium;
notifying means which generates notifying sound based on the end of the image pick-up operation of the still image by the image pick-up means or the end of recording the picked-up still image to the recording medium; and
control means which controls the audio data encoding means and/or the audio data recording means so as not to record, to the recording medium, the audio data corresponding to a period for generating the notifying sound by the notifying means.

10. A recording apparatus according to claim 9, wherein the notifying means generates a plurality of different kinds of the notifying sound.

11. A recording apparatus comprising:
audio recording means which records audio data;
photographing means which photographs a subject during recording the audio data by the audio recording means;
temporary stop means which temporarily stops the audio recording by the audio recording means upon photographing the subject by the photographing means;
notifying means which generates notifying sound after temporarily stopping the audio recording of the audio recording means by the temporary stop means; and
restart means which restarts the audio recording of the audio recording means after ending the generation of the notifying sound by the notifying means.

12. A recording apparatus according to claim 11, wherein the temporary stop means temporarily stops the audio recording of the audio recording means when the still image is successfully photographed by the photographing means and/or when the still image is not successfully photographed.

13. A recording apparatus according to claim 12, wherein the time for temporarily stopping the audio recording by the temporary stop means does not influence the audio data recorded by the audio recording means.

14. A recording apparatus according to claim 13, wherein the time for temporarily stopping the audio recording by the temporary stop means is 30 to 80 msec.

15. A recording apparatus according to claim 13, wherein the time for temporarily stopping the audio recording by the temporary stop means is 40 to 60 msec.

16. A recording apparatus according to claim 13, wherein the time for temporarily stopping the audio recording by the temporary stop means is 50 msec.
